(19) United States
(12) Patent Application Publication
(10) Pub. No.: US 2025/0264668 A1
(43) Pub. Date: Aug. 21, 2025

(54) ADAPTERS AND OPTICAL ASSEMBLIES FOR MATING DISSIMILAR OPTICAL CONNECTORS

(71) Applicant: CORNING RESEARCH & DEVELOPMENT CORPORATION, Corning, NY (US)

(72) Inventors: Lukasz Piotr Janasz, Lodz (PL); Scott William Ramsdell, Charlotte, NC (US)

(21) Appl. No.: 19/056,209

(22) Filed: Feb. 18, 2025

Related U.S. Application Data
(60) Provisional application No. 63/555,641, filed on Feb. 20, 2024.

(51) Int. Cl. G02B 6/38

(52) U.S. Cl. CPC G02B 6/3825; G02B 6/3885; G02B 6/3893

(57) ABSTRACT

An adapter for coupling two dissimilar optical connectors includes a first end and a second end opposite from the first end, where the first end is operable to receive a first optical connector of a first optical connector type and the second end is operable to receive a second optical connector of a second optical connector type. The adapter further includes a receptacle holder and a flange adjacent to the first end, where the receptacle holder extends from the flange and defines a rectangular opening, an adapter body extending from the flange to the second end, and a lock opening within the adapter body and adjacent to the flange. The adapter also includes a lock tab secured within the lock opening such that the lock tab is operable to engage the threads of the second optical connector when the second optical connector is inserted into the adapter.

This application claims the benefit of priority of U.S. Provisional Application Ser. No. 63/555,641 filed on Feb. 20, 2024, the content of which is relied upon and incorporated herein by reference in its entirety.

### BACKGROUND

### Background

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extends deeper into communication networks there exist a need for building more complex and flexible fiber optic networks using fiber optic connectors that are capable of making connections in a quick and easy manner.

Fiber optic connectors were developed for making plug and play optical connections at links or devices in the communication network such as terminals, cabinets, patch panels, and like. The fiber optic connectors allow the distribution of optical signals within an optical network and provide the flexibility of locating the devices in convenient locations for efficient network design and deployment and also deferring connectivity and the associated expense until needed in the communication network. As the deployment of optical networks expands, more multi-fiber optical connectors are needed for building a suitable communications network. Multi-fiber connectors using a ferrule that supports and connects multiple optical fibers at a ferrule mating interface are much more challenging than optical connectors having ferrules that support a single optical fiber. Specifically, optical connectors with ferrules supporting multiple fibers requires the alignment and physical contact of all of the end faces of the multiple optical fibers across the fiber array, and all of optical channels of the optical connector need to meet the optical mating performance specification. Different types of optical connectors exist and are deployed by network operators, but are typically not compatible with newer connector designs. This causes concerns and complexity for network operators for managing their communication networks.

Accordingly, alternative devices and methods for coupling of dissimilar optical connectors are desired.

### SUMMARY

Embodiments of the present disclosure are directed to adapters that enable the mating of two dissimilar optical connectors. The adapters disclosed herein also enable dissimilar optical connectors to be positioned in legacy telecommunications ports designed for electrical cables and connectors, such as ⅝-24 ports. The adapters eliminate the need for fiber splicing within legacy enclosures, thereby reducing installation costs.

In one embodiment, an adapter for coupling two dissimilar optical connectors includes a first end and a second end opposite from the first end, where the first end is operable to receive a first optical connector of a first optical connector type and the second end is operable to receive a second optical connector of a second optical connector type. The adapter further includes a passageway extending from the first end to the second end, a receptacle holder and a flange adjacent to the first end, where the receptacle holder extends from the flange and defines a rectangular opening, an adapter body extending from the flange to the second end, and a lock opening within the adapter body and adjacent to the flange. The lock opening is operable to expose threads of the second optical connector when the second optical connector is inserted into the adapter. The adapter also includes a lock tab secured within the lock opening such that the lock tab is operable to engage the threads of the second optical connector when the second optical connector is inserted into the adapter.

In another embodiment, an adapter assembly includes an adapter and a node. The adapter includes a first end and a second end opposite from the first end, where the first end is operable to receive a first optical connector of a first optical connector type and the second end is operable to receive a second optical connector of a second optical connector type. The adapter further includes a passageway extending from the first end to the second end, a receptacle holder and a flange adjacent to the first end, where the receptacle holder extends from the flange and defines a rectangular opening, an adapter body extending from the flange to the second end, and a lock opening within the adapter body and adjacent to the flange. The lock opening is operable to expose threads of the second optical connector when the second optical connector is inserted into the adapter. The adapter also includes a lock tab secured within the lock opening such that the lock tab is operable to engage the threads of the second optical connector when the second optical connector is inserted into the adapter. The node has a threaded end, wherein the adapter body has a diameter such that it is disposed within the node.

In another embodiment, an optical assembly includes a first optical connector of a first optical connector type, a second optical connector of a second optical connector type, and an adapter. The adapter includes a first end and a second end opposite from the first end, where the first end is operable to receive the first optical connector and the second end is operable to receive the second optical connector. The adapter further includes a passageway extending from the first end to the second end, a receptacle holder and a flange adjacent to the first end, where the receptacle holder extends from the flange and defines a rectangular opening, an adapter body extending from the flange to the second end, and a lock opening within the adapter body and adjacent to the flange, where the lock opening is operable to expose threads of the second optical connector when the second optical connector is inserted into the adapter. The adapter also includes a lock tab secured within the lock opening such that the lock tab is operable to engage the threads of the second optical connector when the second optical connector is inserted into the adapter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a partial exploded view of two dissimilar optical connectors and an adapter according to one or more embodiments described and illustrated herein.

FIG. 2 illustrates a perspective view of two dissimilar optical connectors mated using an adapter according to one or more embodiments described and illustrated herein.

FIG. 3 illustrates a perspective view of an example adapter according to one or more embodiments described and illustrated herein.

FIG. 4 illustrates a cross-sectional view of an example adapter according to one or more embodiments described and illustrated herein.

FIG. 5 illustrates a node within a wall of an enclosure, a first optical connector, a second optical connector and an adapter in an unmated state according to one or more embodiments described and illustrated herein.

FIG. 6 illustrates a node within a wall of an enclosure, a first optical connector, a second optical connector and an adapter in a mated state according to one or more embodiments described and illustrated herein.

FIG. 7 illustrates a perspective view of a node, a first optical connector, a second optical connector, and an adapter in an unmated state according to one or more embodiments described and illustrated herein.

FIG. 8 illustrates a perspective view of a node, a first optical connector, a second optical connector, and an adapter in a partially mated state according to one or more embodiments described and illustrated herein.

FIG. 9 illustrates a perspective view of a node, a first optical connector, a second optical connector, and an adapter in a mated state according to one or more embodiments described and illustrated herein.

### DETAILED DESCRIPTION

Embodiments of the present disclosure are directed to adapters for coupling two dissimilar optical connectors, as well as optical assemblies that include such adapters. The adapter comprises a receptacle holder and a receptacle for receiving the second optical connector. The optical interface of the ferrule of the first optical connector is disposed within the receptacle to mate with the optical interface of the second optical connector also within the receptacle. The adapter further includes a locking mechanism to lock the first optical connector within the adapter.

In addition to enabling the mating of two dissimilar optical connectors, the adapters described herein also leverage legacy telecommunication connection equipment such that enclosure nodes designed for legacy communication cables and connectors (e.g., cable television cables and connectors) can be used for fiber optic communication cables and connectors. The adapters disclosed herein have an adapter body that is dimensioned to fit within enclosure nodes, such as The Society of Cable Telecommunication Engineers (SCTE) standard ⅝-24 ports. Thus, optical cables and optical connectors can be used in nodes/ports designed for electrical cables and connectors. Enabling optical mating within the enclosure using connectors eliminates the need for fiber splicing within the enclosure, which is time consuming and costly.

Various embodiments of optical adapters for mating dissimilar optical connectors and optical assemblies are described in detail below.

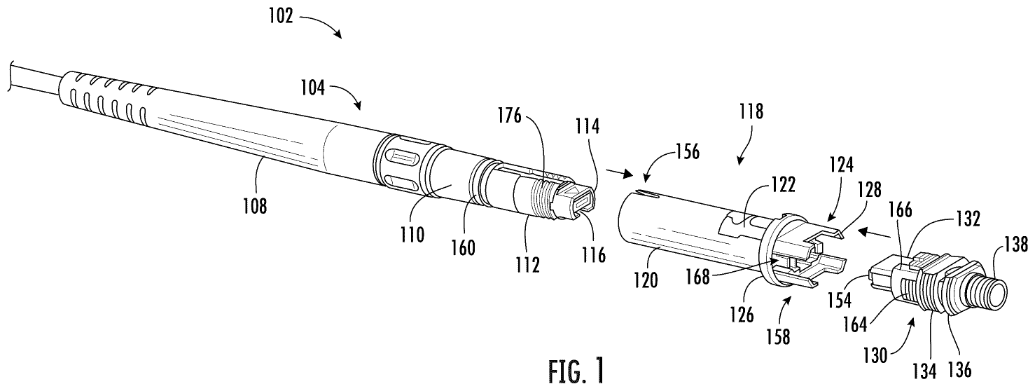

Referring now to FIG. 1, and example optical connector assembly 100 is schematically illustrated. The optical connector assembly 100 generally includes a first optical connector 104 of a first optical connector type, an adapter 118, and a second optical connector 130 of a second optical connector type. The first optical connector type and the second optical connector type are dissimilar from one another. As a non-limiting example, the first optical connector type of the first optical connector 104 may be a multi-fiber Pushlok® optical connector sold by Corning Optical Communications of Charlotte, North Carolina. Additional information regarding example multi-fiber Pushlok® optical connectors is provided in U.S. Pat. Publ. No. 2023/0204867, which is hereby incorporated by reference in its entirety. The second optical connector type of the second optical connector 130 may be a traditional multi-fiber push-on (MPO) optical connector type, for example. As described in more detail below, the adapter 118 is operable to provide coupling between the two dissimilar optical connector types.

The first optical connector 104 is illustrated as a component of an optical cable assembly 102 that further includes an optical cable 106 having a plurality of optical fibers. The first optical connector 104 comprises a ferrule 116, a nosepiece 114, a connector housing 112, and a boot 110. The nosepiece 114 surrounds the ferrule 116, which in some embodiments is biased (e.g., by a spring) in a positive z-axis direction. The nosepiece 114 has a non-round cross-section to accommodate the ferrule 116.

The connector housing 112 comprises a rear end and a front end with a longitudinal passageway extending therebetween. The ferrule 116 comprises a plurality of bores (not shown) for receiving one or more optical fibers (not shown) within the optical cable 106. By way of example, the ferrule 116 may be a MT or MPO ferrule, but other suitable ferrule are possible using the disclosed concepts. The connector housing 112 has a generally round cross-section or cylindrical sleeve. The boot 110 is coupled to a rear of the connector housing 112, such as by a snap fit, for example.

The second optical connector type of the second optical connector 130 may be a MPO-type optical connector having a configuration that is different from the first optical connector 104. The second optical connector 130 includes an MPO nosepiece 132 that surrounds a multi-fiber ferrule 154 comprising a plurality of bores (not shown) for receiving and maintaining a plurality of optical fibers (not shown). The second optical connector 130 further includes a body 134 having threads 164 and an arm receiving portion 166 for receiving arms 128 of the adapter 118 as described in more detail below. In embodiments the second optical connector 130 may include a sealing element 136 for protecting the mating optical interface from the external environment and a threaded end 138.

Despite both the first and second optical connectors 104, 130 having similar MT or MPO ferrules 116, 154, due to the differences in physical characteristics between the two connectors and that they are both male optical connectors, the first and second optical connectors 104, 130 cannot mate with one another. However, the adapter 118 is designed to enable mating between the first optical connector 104 and the second optical connector 130. As described in more detail below, the adapter 118 converts the first optical connector 104 from a male connector to a female connector to enable the first optical connector 104 to be optically mated with the second optical connector 130.

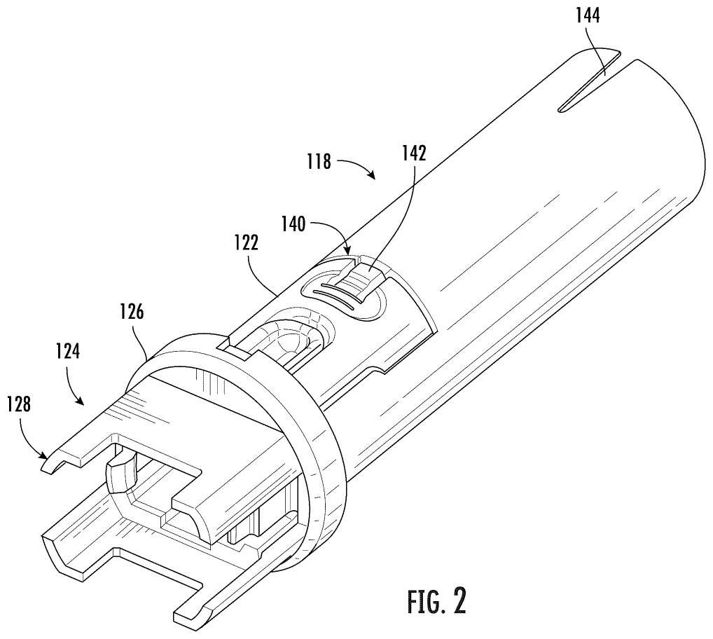

FIG. 2 illustrates a perspective view of the example adapter 118 of FIG. 1 for enabling mating between the dissimilar first optical connector 104 and second optical connector 130. Referring to both FIG. 1 and FIG. 2, the adapter 118 includes a receptacle holder 124 extending from a flange 126 in a positive z-axis direction and an adapter body 120 extending from the flange 126 in a negative z-axis direction. A passageway extends between a first end 156 and a second end 158 of the adapter 118. As shown in FIG. 1, the cylindrical adapter body 120 is operable to receive the first optical connector 104 at the first end and the receptacle holder 124 is operable to receive the second optical connector 130 at the second end 158. The adapter body 120 has a cylindrical shape with an internal diameter corresponding to an outer diameter of the connector housing 112.

In some embodiments, the first end 156 has a slit 144 that enables the adapter body 120 to fit over a flange 160 of the connector housing 112 having an increased outer diameter from the remainder of the connector housing 112. The slit 144 opens up when the first end 156 of the adapter 118 is positioned over the flange 160, causing an interference fit between the first end 156 of the adapter body 120 and the flange 160 of the connector housing 112.

The receptacle holder 124 at the second end 158 of the adapter 118 is sized and shaped to receive the body 134 of the second optical connector 130. The receptacle holder 124 generally includes four arms 128 that are operable to fit on the arm receiving portion 166 of the body 134. The arms 128 may flex to open up when in contact with the arm receiving portion 166. In this manner the arms 128 maintain a mated relationship between the adapter 118 and the second optical connector 130.

The receptacle holder 124 surrounds a receptacle 168 that is sized and shaped to receive the MPO nosepiece 132 of the second optical connector 130. When the second optical connector is inserted into the receptacle holder 124 the MPO nosepiece 132 resides within the receptacle 168. The MPO nosepiece 132 may be coupled to the receptacle 168 by an interference fit, for example.

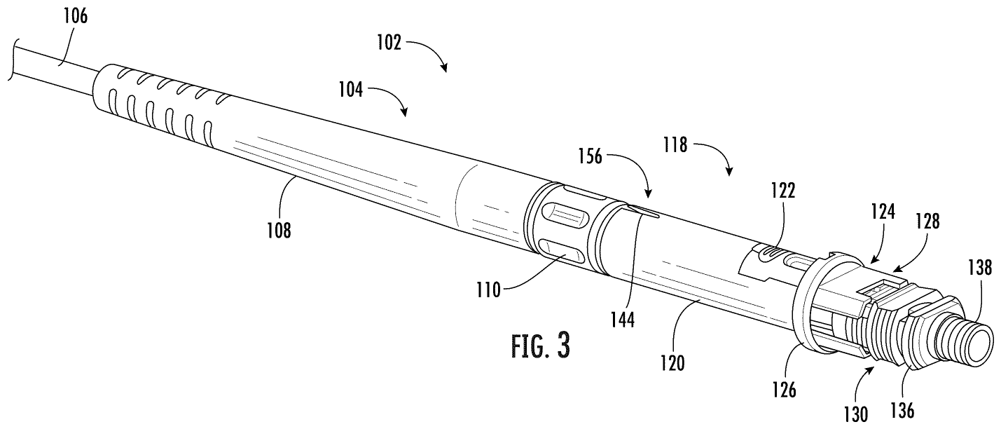

FIG. 3 illustrates the first optical connector 104 mated to the second optical connector by way of the adapter. The adapter 118 is operable to align the front faces of the two ferrules 116, 154. First optical connector 104 is inserted into the first end 156 such that the slit 144 is positioned over the flange 160 of the connector housing 112 and the first end 156 abuts an edge of the boot 110.

The adapter 118 includes a lock opening 140 and a lock tab 122 to securely lock the first optical connector 104 to the adapter 118. The lock opening 140 is generally U-shaped and exposes the threads 146 of the connector housing 112 disposed within the adapter body 120. The lock tab 122, which is also generally U-shaped, snaps into the connector housing 112 to engage the threads 146 of the connector housing 112 to prevent the first optical connector 104 from being pulled out of the adapter 118.

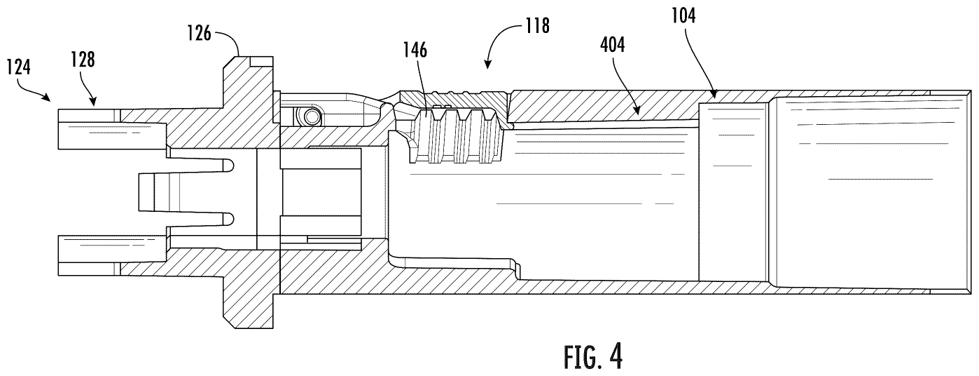

FIG. 4 illustrates a cross-sectional view of the adapter 118 as well as the threads 146 of a connector housing 112 of a first optical connector 104. When the connector housing 112 is fully inserted into the adapter 118, the threads 146 are exposed within the lock opening 140 of the adapter 118. The lock tab 122 is disposed within the lock opening 140 to engage the threads 146 to thereby lock the first optical connector 104 to the adapter 118. In some embodiments, the lock tab 122 is a loose component that snaps into the lock opening 140. In the embodiment of FIG. 4, the lock tab 122 rotationally mates with the adapter 118 by a pivot point 176. The pivot point 176 may be defined by a portion of the lock tab 122 that snaps into recesses of the adapter 118, or by a pivot pin that extends through both the lock tab 122 and the adapter 118.

The lock tab 122 includes features that are configured to engage the threads 146 of the connector housing 112. As one non-limiting example, the bottom surface of the lock tab 122 includes threads corresponding to the threads 146 of the connector housing 112 to lock the first optical connector 104 to the adapter 118. As another non-limiting example, the lock tab 122 includes a capture portion 174 at an end that engages an end of the threads 146 to lock the first optical connector 104 to the adapter. The capture portion 174 may also be wedged under the adapter body 120 to further secure and snap the lock tab 122 within the lock opening 140.

The first optical connector 104 is unlocked from the adapter 118 by removing the lock tab 122 from the lock opening 140 by either pulling the lock tab 122 out of lock opening 140, or by rotating the lock opening 140 about the pivot point 176 out of the lock opening.

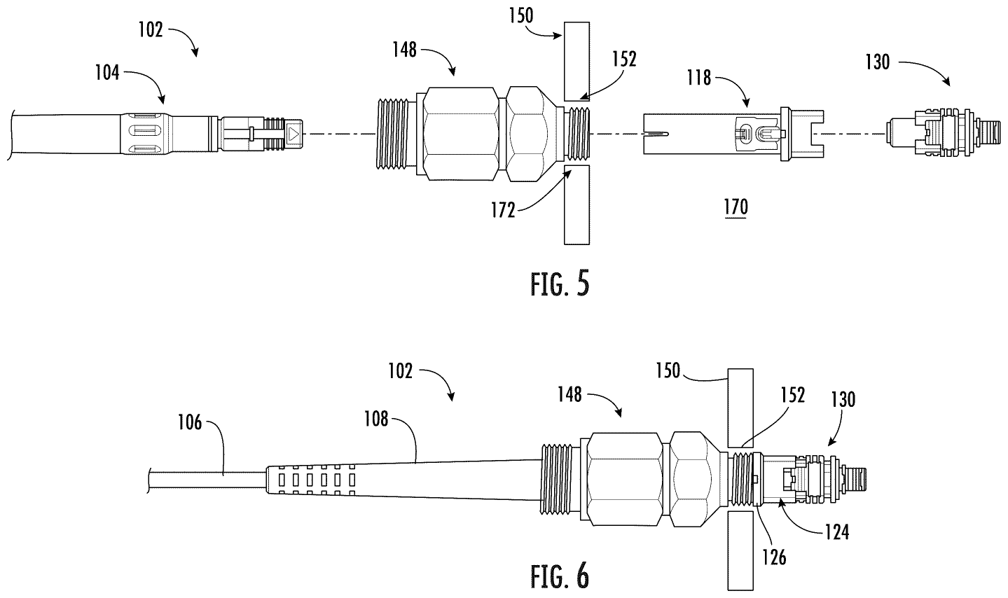

Referring now to FIG. 5, the adapter 118 not only allows the mating of dissimilar optical connectors but also enables a multi-fiber optical connector such as the first optical connector 104 to be used in outdoor infrastructure utilized by multi-system operators (MSO), such as cable TV operators. More particularly, the adapter 118 is operable to fit within a metal node 148 compatible with the SCTE standard for ⅝-24 ports. Thus, the adapter 118 described herein allows fiber communication hardware and cables to be utilized in historical cable telecommunication ports and enclosures. Current solutions require the optical cable to be run through the node and then spliced within the enclosure. Embodiments of the present disclosure allow for a simpler connection solution without the need for splicing.

FIG. 5 illustrates an enclosure wall 150 defining an enclosure interior 170. The enclosure defined by the enclosure wall 150 may be any type of enclosure, such as an outdoor telecommunications enclosure. A node 148 having a threaded end 152 is screwed into the opening 172 of the wall 150 of the enclosure. As stated above, the node 148 may be an SCTE standard ⅝-24 port. The first end 156 of the adapter 118 is inserted into the node 148 from the enclosure interior 170. The first optical connector 104 is inserted into the node 148 from the exterior of the wall 150.

FIG. 6 illustrates a first optical connector 104 mated to a second optical connector 130 through a node 148 disposed within a wall 150 of an enclosure by way of an adapter 118. The hardened first optical connector 104 is mated to the second optical connector 130, which may be or may not be hardened. As used herein, “hardened” means that it is suitable for exterior environments.

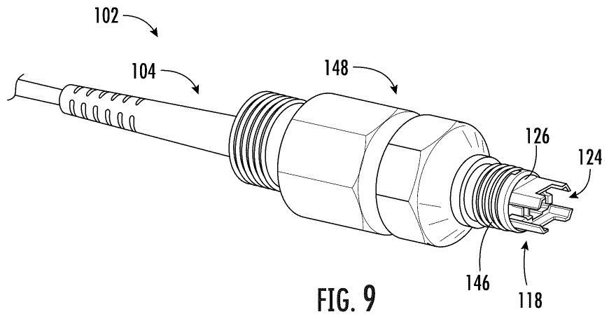

FIGS. 7-9 illustrate perspective views of a process for coupling a first optical connector 104 to a second optical connector 130 using an adapter 118 as well as through a telecommunications node 148. Referring to FIG. 7, the first optical connector 104 is pushed through the node 148, which may be secured to a wall of an enclosure, as described above. The adapter 118 is positioned within the enclosure interior 170 and is slid onto the connector housing 112 of the first optical connector 104 in a direction as indicated by the arrow.

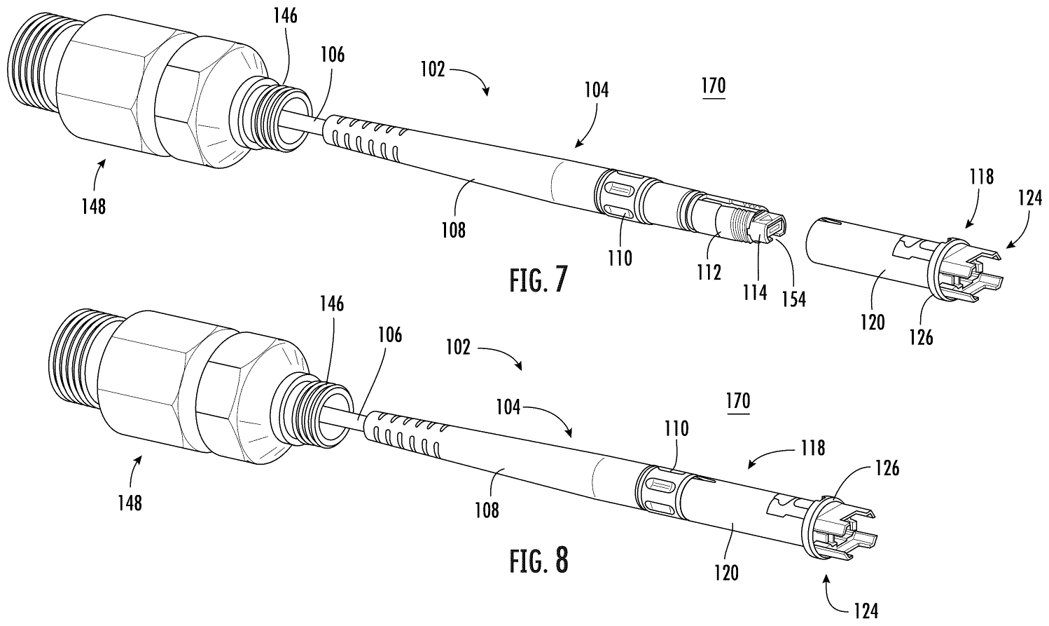

Referring to FIG. 8, the adapter 118 is locked to the connector housing 112 by way of the lock tab 122 and features of the connector housing 112, such as the threads 146. When the adapter 118 is fully seated on the connector housing 112 the lock tab is snapped into the lock opening 140 to lock the first optical connector 104 to the adapter 118.

After the adapter 118 is locked onto the connector housing 112 of the first optical connector 104, the first optical connector 104 and the adapter 118 are pulled back toward the node 148 until the flange 126 of the adapter 118 contacts the end of the node 148. The adapter body 120 is secured within the node 148 by an interference fit, for example.

The adapter 118 provides a receptacle for mating with the second optical connector 130, such as an MPO optical connector within an enclosure. Thus, embodiments of the present disclosure provide the ability to couple two dissimilar optical connectors using legacy telecommunications hardware, such as cable television nodes/ports.

It should now be understood that embodiments of the present disclosure are directed to adapters for coupling two dissimilar optical connectors. A first optical connector may be a male Pushlok® connector and a second optical connector may be a male MPO optical connector which are not generally compatible with one another despite both having a multi-fiber MT or MPO ferrule. The adapter comprises a receptacle holder and a receptacle for receiving the second optical connector. The optical interface of the ferrule of the first optical connector is disposed within the receptacle to mate with the optical interface of the second optical connector within the receptacle. The adapter includes a locking mechanism to lock the first optical connector within the adapter. The locking mechanism includes a lock opening within the adapter body and a lock tab that snaps into the lock opening.

In addition to enabling the mating of two dissimilar optical connectors, the adapters described herein also leverage legacy telecommunication equipment such that enclosure nodes designed for legacy communication cables and connectors (e.g., cable television cables and connectors) can be used for fiber optic communication cables and connectors. The adapters disclosed herein have an adapter body that is dimensioned to fit within enclosure nodes, such as Society of Cable Telecommunication Engineers (SCTE) standard ⅝-24 ports. Thus, optical cables and optical connectors can be used in nodes/ports designed for electrical cables and connectors.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application covers the modifications and variations provided they come within the scope of the appended claims and their equivalents.

What is claimed is:

1. An adapter for coupling two dissimilar optical connectors comprising:
a first end and a second end opposite from the first end, wherein the first end is operable to receive a first optical connector of a first optical connector type and the second end is operable to receive a second optical connector of a second optical connector type;
a passageway extending from the first end to the second end;
a receptacle holder and a flange adjacent to the first end, wherein the receptacle holder extends from the flange and defines a rectangular opening;
an adapter body extending from the flange to the second end;
a lock opening within the adapter body and adjacent to the flange, wherein the lock opening is operable to expose threads of the second optical connector when the second optical connector is inserted into the adapter; and
a lock tab secured within the lock opening such that the lock tab is operable to engage the threads of the second optical connector when the second optical connector is inserted into the adapter.

2. The adapter of claim 1, wherein the adapter body has a diameter for insertion into a node positioned within a wall.

3. The adapter of claim 2, wherein the node is a ⅝-24 port as specified by The Society of Cable Telecommunication Engineers (SCTE).

4. The adapter of claim 1, wherein the passageway is shaped to accept the first optical connector type at the first end and to accept the second optical connector type at the second end.

5. The adapter of claim 1, wherein the lock tab comprises a release button for releasing the second optical connector from the adapter.

6. The adapter of claim 1, wherein the first optical connector and the second optical connector are each multi-fiber connectors.

7. The adapter of claim 1, wherein the first optical connector type is a multi-fiber push-on optical connector type.

8. The adapter of claim 1, wherein the lock opening and the lock tab are U-shaped.

9. The adapter of claim 1, wherein the lock tab includes a threaded surface for engaging the threads of the second optical connector.

10. An adapter assembly comprising:
an adapter comprising:
a first end and a second end opposite from the first end, wherein the first end is operable to receive a first optical connector of a first optical connector type and the second end is operable to receive a second optical connector of a second optical connector type;
a passageway extending from the first end to the second end;
a receptacle holder and a flange adjacent to the first end, wherein the receptacle holder extends from the flange and defines a rectangular opening;
an adapter body extending from the flange to the second end;
a lock opening within the adapter body and adjacent to the flange, wherein the lock opening is operable to expose threads of the second optical connector when the second optical connector is inserted into the adapter; and
a lock tab secured within the lock opening such that the lock tab is operable to engage the threads of the second optical connector when the second optical connector is inserted into the adapter; and
a node having a threaded end, wherein the adapter body has a diameter such that it is disposed within the node.

11. The adapter assembly of claim 10, wherein the node is a ⅝-24 port as specified by The Society of Cable Telecommunication Engineers (SCTE).

12. The adapter assembly of claim 10, wherein the passageway is shaped to accept the first optical connector type at the first end and to accept the second optical connector type at the second end.

13. The adapter assembly of claim 10, wherein the lock tab comprises a release button for releasing the second optical connector from the adapter.

14. The adapter assembly of claim 10, wherein the first optical connector and the second optical connector are each multi-fiber connectors.

15. The adapter assembly of claim 10, wherein the first optical connector type is a multi-fiber push-on optical connector type.

16. The adapter assembly of claim 10, wherein the lock opening and the lock tab are U-shaped.

17. The adapter assembly of claim 10, wherein the lock tab includes a threaded surface for engaging the threads of the second optical connector.

18. An optical assembly comprising:
a first optical connector of a first optical connector type;
a second optical connector of a second optical connector type; and
an adapter comprising:
a first end and a second end opposite from the first end, wherein the first end is operable to receive the first optical connector and the second end is operable to receive the second optical connector;
a passageway extending from the first end to the second end;
a receptacle holder and a flange adjacent to the first end, wherein the receptacle holder extends from the flange and defines a rectangular opening;
an adapter body extending from the flange to the second end;
a lock opening within the adapter body and adjacent to the flange, wherein the lock opening is operable to expose threads of the second optical connector when the second optical connector is inserted into the adapter; and
a lock tab secured within the lock opening such that the lock tab is operable to engage the threads of the second optical connector when the second optical connector is inserted into the adapter.

19. The adapter of claim 18, wherein the adapter body has a diameter for insertion into a node positioned within a wall.

20. The adapter of claim 19, wherein the node is a ⅝-24 port as specified by The Society of Cable Telecommunication Engineers (SCTE).

21. The adapter of claim 18, wherein the passageway is shaped to accept the first optical connector type at the first end and to accept the second optical connector type at the second end.

22. The adapter of claim 18, wherein the lock tab comprises a release button for releasing the second optical connector from the adapter.

23. The adapter of claim 18, wherein the first optical connector and the second optical connector are each multi-fiber connectors.

24. The adapter of claim 18, wherein the first optical connector type is a multi-fiber push-on optical connector type.

25. The adapter of claim 18, wherein the lock opening and the lock tab are U-shaped.

26. The adapter of claim 18, wherein the lock tab includes a threaded surface for engaging the threads of the second optical connector.
